(19) United States
(12) Patent Application Publication
(10) Pub. No.: US 2004/0255507 A1
(43) Pub. Date: Dec. 23, 2004

(54) Tank retention sling

(75) Inventors: Richard E. Belmont, Winston-Salem, NC (US); Richard E. Achor, Winston-Salem, NC (US); William Todd Hurst, Greensboro, NC (US)

Correspondence Address: GREER, BURNS & CRAIN, LTD., Suite 2500, 300 South Wacker Drive, Chicago, IL, 60606, US

(73) Assignee: CPD ASSOCIATES, INC.

(21) Appl. No.: 10/464,954

(22) Filed: Jun. 19, 2003

(51) Int. Cl. A01M 1/20

(52) U.S. Cl. 43/107

(57) ABSTRACT

A tank cart for an LP tank includes a cart configured for holding an LP tank. The cart includes a frame, at least one wheel and a handle. At least one generally rigid attachment bar is included as a portion of the frame to support an elongated sling that wraps around a side of the LP tank. A means is included for releasably attaching the sling to the frame. When the sling is in place, it supports the tank against the frame to prevent the tank from slipping when the cart is moved to a different location. In a preferred embodiment, the cart is used with an insect trap that utilizes a fuel from a fuel tank to generate gasses that attract insects.

### BACKGROUND OF THE INVENTION

This invention relates to a cart for a gas cylinder. More specifically, this invention relates to a cart for an insect trap that utilizes propane or other gases from a tank or cylinder, that releasably supports the gas cylinder.

Concern about West Nile Virus and other diseases borne by mosquitoes has produced a demand for products that reduce the mosquito population in outdoor areas inhabited by people. People want to be able to use their yard, parks or swimming pools on summer evenings when mosquito activity is at its peak. The market for yard and patio appliances now includes a number of insect traps, including those that electrocute insects, immobilize them on a sticky substance or use a fan to suck insects into a net or a compartment.

One type of insect trap that has become popular uses attractants to lure insects to the trap, then suction to draw them into the trap where they are confined or killed. These traps are particularly effective for mosquitoes. A number of attractants have been identified that lure the mosquitoes to the trap from various distances. The light weight of the mosquito requires less suction to draw it into the trap than heavier insects. Mosquitoes confined in the trap may be removed for study, left in the trap where they eventually dehydrate and die, or may be killed by another means. Suction traps of this type are sold commercially under tradenames such as MOSQUITO MAGNET (American Biophysics Corp.), Mosquito Trap (Lentek), MEGA-CATCH Mosquito Trap, SKEETERVAC (Blue Rhino Corp.) and the Mosquito Power Trap.

A variety of attractants may be used to lure the insects to the trap or to specific portions of the trap. Some species of mosquitoes are attracted by visual cues such as light or color. Other species react to sound. The female mosquito seeks a target for a blood meal with which to fertilize her eggs. To this end, females are attracted to targets that signal the presence of a warm-blooded animal, such as warmth and chemicals produced by such animals. Carbon dioxide, water vapor, pheremones and octenol are examples of attractant chemicals that mimic aromas of animals or by-products of respiration and sweat. Selectively attracting and eliminating the females interrupts the reproductive cycle to more effectively reduce the mosquito population. Traps often include a variety of attractants to appeal to a large number of mosquito species.

Carbon dioxide, water vapor and heat are all generated by hydrocarbon combustion. Self-contained insect traps have been designed that bum propane gas. Combustion reactions provide carbon dioxide, moisture and heat, some of which is converted into electrical energy to power the suction fan, thereby producing both power for the trap and chemical attractants to lure insects. When a 20 lb. propane tank is associated with the insect trap, power and attractants are supplied for about one month, and it eliminates the need for electrical power. This allows complete freedom as to placement of the trap without regard to the availability of an electrical outlet.

For ease in positioning the trap, the propane tank is commonly included on a cart with the insect trap. If the cart only has two wheels, it is tipped, the frame rotates about the wheel axle, and the cart is dragged to its new position. During movement, the tank can tip and fall from the cart if not properly secured. U.S. Pat. No. 6,145,243 to Wigton shows the use of a retaining hook that is secured to the upright post. Internet literature on the MOSQUITO MAGNET FREEDOM Model trap shows a cap that fits around the top of the tank collar. The cap is integrally formed in an arm that is secured to an upright post. Both of these prior art support methods stabilize the tank from the top, near the collar. Other traps, such as the Lentek Mosquito Trap, use a ring into which the tank bottom rests, preventing the bottom from moving from side-to-side.

However, when the cart is tipped to move it, the gravitational force on the tank is no longer limited to a component that is parallel to the longitudinal axis of the tank. Gravity also tends to pull the tank sideways toward the ground when the legs are raised up from the ground to free the wheels. If the tank is supported from the top, the tank bottom could slip and cause the tank to dislodge. When the tank is supported only from the bottom, the side force cold cause the top of the tank to shift, particularly when the tank is full.

It is also known that insects are attracted to certain colors and repelled by others. Often, the user has no choice concerning the color of the propane tank received. If a propane tank is received in a color that repels insects, it may serve to discourage insects from approaching the trap. Also, if the color of the tank is overly attractive to the insects, they may gather around the tank and not be drawn to the capture zone of the trap. Since the propane tank makes up a significant portion of the visual profile of the overall trap unit, the ability to avoid colors or visual patterns on the tank that might confuse the insects would be beneficial.

Use of a large appliance, such as an insect trap, in one's backyard may also be more acceptable to a potential purchaser if the trap could be made more visually appealing to people as well. The ability to make the trap more attractive to the humans as well as the insects may increase sales for a particular insect trap over its competitors.

Therefore, it would be desirable to provide a means for supporting a tank on a cart that would provide support at the side of the tank from which gravity would pull on the tank when the cart was tipped for movement. It would also be desirable to attract insects to the trap by visual cues on the tank rather than repel them. There is also a need to make insect traps more appealing to the humans who purchase them.

### SUMMARY OF THE INVENTION

These and other needs are met by the present invention that features a cart for an insect trap and a gas tank that releasably supports the tank. The cart includes a tank retention sling to support the tank when the cart is moved. In addition, the sling has a decorative color or pattern that is pleasing to humans but does not misdirect the insects from approaching the trap.

More specifically, a tank cart for an LP tank includes a cart configured for holding an LP tank. The cart includes a frame, at least one wheel and a handle. At least one generally rigid attachment bar is included as a portion of the frame to support an elongated sling that wraps around a side of the LP tank. A means is included for releasably attaching the sling to the frame. When the sling is in place, it supports the tank against the frame to prevent the tank from slipping when the cart is moved to a different location.

In a preferred embodiment, the cart also holds an insect trap that utilizes the gas from the tank to attract insects toward the trap. As the insect population is depleted in one area or the wind shifts from a different direction, it is often advantageous to move the insect trap to a new location. When the cart is tipped to wheel it to a different location, the sling supports the tank and prevents its movement in response to the component of the gravitational force that urges the tank in a direction that is opposite the direction from the axle to the handle.

The sling also covers a large portion of the tank surface area. Preferably, the color or pattern on the sling is neutral to mosquitoes, so that it neither attracts nor repels mosquitoes. Mosquitoes are be attracted to an appropriate portion the trap by the attractants and are be drawn into the capture zone. There is no diversion of insects from the trap to the tank, increasing the efficacy of the insect trap. The decorative finish on the sling can also be made pleasing to humans.

### DETAILED DESCRIPTION OF THE DRAWINGS

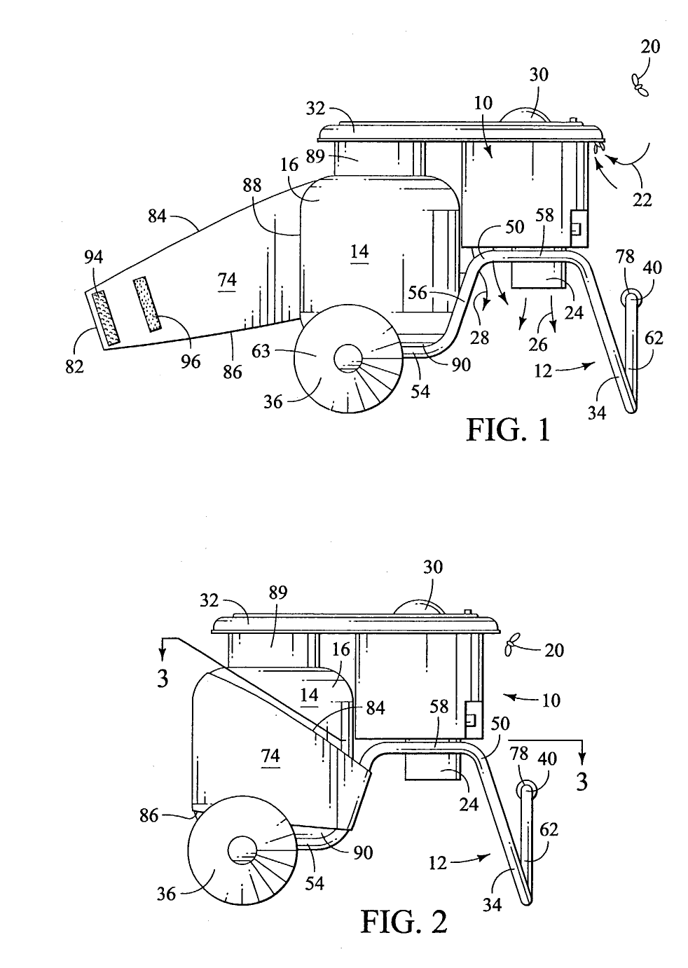

FIG. 1 shows a side view of a cart with the tank retention sling of the present invention with the second short side of the sling unattached;

FIG. 2 shows a side view of the cart with the tank retention sling wrapped around an LP with the second short side of the sling attached to the cart frame;

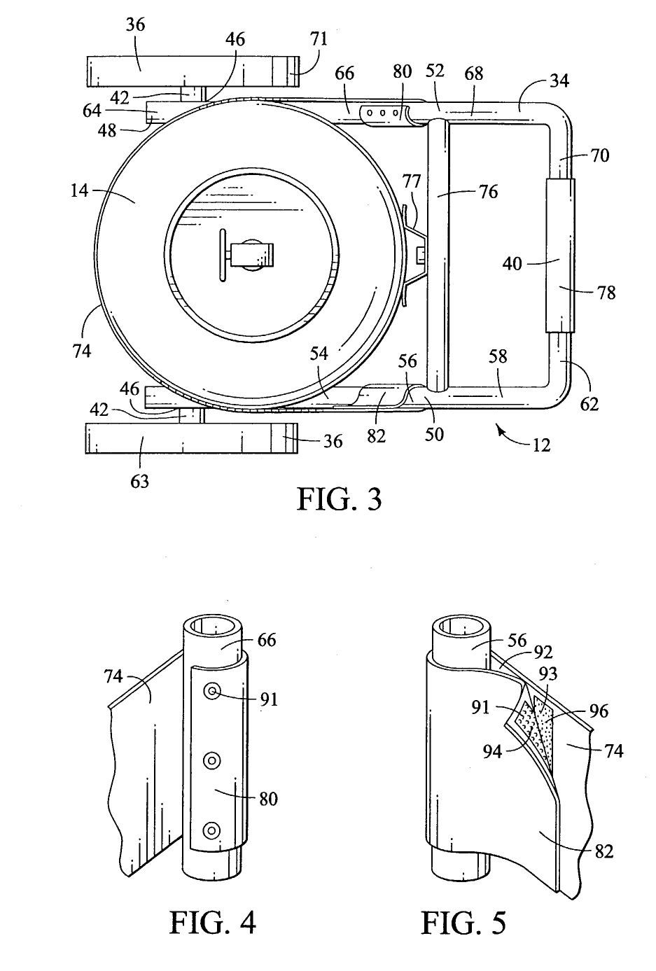

FIG. 3 shows a top view of the cart and tank retention sling;

FIG. 4 is a detail of the back attachment bar with the first short side of the sling permanently attached; and

FIG. 5 is a detail of the front attachment bar with the second short side of the sling releasably attached.

### DETAILED DESCRIPTION OF THE INVENTION

As shown in FIGS. 1 and 2, this invention relates to an insect trap, generally designated 10, and a cart, generally designated 12, that supports a gas cylinder 14. In the discussion that follows, directional references are to be interpreted as though the insect trap 10 and cart 12 are oriented as shown in FIG. 1.

Many types of the insect traps 10 are known and are suitable for use with this invention, including suction traps, traps that use sticky paper or glue boards to immobilize insects or electrocution traps. Any type of insect trap 10 is usable with this invention utilizes a gas 16 from a cylinder 14 to attract insects 20. Choice of the type of trap 12 is frequently based on the type of insects 20 that are targeted for eradication.

FIGS. 1 and 2 show the insect trap 10 as a suction trap. Suction air 22 and insects 20 are drawn into the trap 10 by a suction fan (not shown). The insects 20 are caught in the porous trap cup 24, while the fan exhaust 26 exits through the trap cup. Attractant gases 28, such as carbon dioxide, are provided directly by the tank 14 or are indirectly generated via combustion and exit the trap 10 and are dissipated into the atmosphere to lure the insects 20 to the vicinity of the trap 10. Additional chemical, scent-based attractants, such as octenol or pheremones, are optionally distributed through an optional dispenser 30. An optional cover 32 protects the top of the trap 10 or both the trap and the tank 14.

The gas 16 to be used with the insect trap 10 is used to attract the insects 20, either directly or indirectly. In some embodiments, carbon dioxide is used to attract female mosquitoes to the trap 12. Indirect use of the gas 16 is where, as shown in the preferred embodiment, the gas is a fuel that is burned in a combustion chamber (not shown) to produce carbon dioxide, heat and water vapor. The gas 16 is used directly where the tank 14 supplies carbon dioxide that is discharged to the atmosphere from the trap 10 or any location to which the insects 20 are to be attracted. It is preferable to use the gas 16 that directly attracts insects 20 if attractants other than carbon dioxide are used or if the trap 10 does not require power for other purposes, such as operation of the suction fan. Where auxiliary power is required, the gas 16 that produces attractants indirectly through combustion may be preferred. Heat from combustion is optionally used to generate electricity using a thermoelectrical converter, eliminating the need to operate the insect trap 10 near a source of electricity. In this embodiment, propane is the preferred gas 16 due to its ready availability for use with gas grills.

The exact size and shape of the gas tank 14 or cylinder will depend on the type of gas 16 used and the quantity that is desired. Cylinders 16 of carbon dioxide that are useful are commonly available from beverage distributors. The preferred gas 16, propane, is available in tanks that hold one pound or more of fuel. A 20 lb. propane tank 14 is preferred due to its ready availability and the reduced need to change the cylinder frequently, particularly when the trap 10 is operated continuously.

Both the insect trap 10 and the tank 14 are held on a cart 12 so that the entire unit can be wheeled to any desired location. When the insect trap 10 is to be moved to a different location, use of the cart 12 eliminates the need to disconnect the tank 14 from the trap, move them separately, then reconnect the tank to the trap. The cart 12 includes a frame 34, at least one wheel 36 and a handle 40. Although the single wheel 36 is useful to move the cart 12 like a wheelbarrow, preferably the cart includes two or more wheels.

As shown in FIG. 3, the cart 12 includes two wheels 36, one on either side of the cart, with an axle 42 between them. The axle 42 is mounted through axle bores 46 through the frame 34. During movement of the cart 12, the cart is tipped by an upward force on the handle 40, causing the frame 34 to rotate about the axle 42. A rear portion 48 of the frame 34, opposite the handle 40 from the axle 42, rotates toward the substrate. Embodiments having more than one of the axles 62 or including three or more of the wheels 36 are also suitable.

The frame 34 is preferably an open structure. As shown in the embodiment of FIG. 1, the cylinder 14 and the trap 10 rest on the frame 34 rather than being inside a closed structure. The frame 34 is constructed from any suitable material. Preferably, the frame 34 is constructed from plastic or metal stock in the shape of pipes or bar stock, including T-bar, that is bent to form an appropriate shape. The frame 34 is optionally made from a single, continuous piece of material or is constructed of parts that are soldered, welded, glued or coupled together as necessary. Metal pipe, such as steel or aluminum, is the preferred frame material, as it is bendable to form a variety of shapes. Plastic pipe, such as polyvinyl chloride pipe is also suitable. It is moldable into a variety of different shapes and sizes.

Referring to FIGS. 1 and 3, a front portion 50 of the frame 34 is visible. The frame 34 is symmetrical with respect to the depth of the frame, thus there is a back portion 52. As the front portion 50 of the frame 34 is described, including a front tank support 54, a front attachment bar 56, a front trap support 58, a front leg 62 and a front wheel 63, it is understood that a corresponding back tank support 64, a back attachment bar 66, a back trap support 68 back leg 70 and back wheel 71 are arranged in the same manner.

Starting at the end closest to the axle 42, the frame 34 of this embodiment provides the front tank support 54. The front tank support 54 is a generally horizontal portion upon which the tank 14 or cylinder rests. This horizontal portion 54 has sufficient length that the tank 14 rests thereon without substantially hanging over the rear portion 48 of the frame 34. Alternately, a platform (not shown) for holding the tank 14 is optionally held between the front tank support 54 and the corresponding back tank support 64.

Moving along the frame 34 toward the front leg 62, at the end of the front tank support 54, the frame 34 turns upward in a generally vertical direction to form a front attachment bar 56. Preferably, the front attachment bar 56 is substantially vertical, or at an angle of at least 45° from the horizontal. The vertical displacement of the front attachment bar 56 is preferably equal to the approximate difference in height between the tank cylinder 14 and the insect trap 10. When this configuration is used, the top of the tank 14 and the top of the insect trap 10 will be at approximately the same height. This optional arrangement is used for aesthetic purposes or so that a single cover 32 can be used to protect both pieces of equipment.

Different frame 34 configurations are possible where only a single bar, such as the front attachment bar 56 is present. The front attachment bar 56 need not connect the front tank support 54 and the front trap support 58, although this is a preferred arrangement. It is possible that the front attachment bar 56 be attached to the frame 34 at a lower end, but be unattached to the frame at an upper end. All that is required is that the front attachment bar 56 provide support to a sling 74 which is wrapped around the side of the gas cylinder 14.

At the top of the front attachment bar 56, the frame 34 again turns toward the front leg 62 to form the front trap support 58. The front trap support 58 should have sufficient length that the trap is securely held thereon. The trap 10 is optionally supported by a trap support platform (not shown) held between the front trap support 58 and the back trap support 68. Optionally, a cross brace 76 is placed between the front trap support 58 and the back trap support 68. This cross brace 76 not only adds rigidity to the frame 34, but it also provides an additional support for the insect trap 10, making it more stable than if the insect trap were balanced between the front trap support 58 and the back trap support 68. An optional standoff 77 holds the tank 14 in an upright position, particularly when tension is applied by the sling 74 that tends to push the tank toward the trap 10.

From the front trap support 58, the frame 34 turns downward to form the front leg 62. The vertical displacement of the front leg 62 is sufficient to permit the tank and the trap to rest substantially levelly on the frame 34. Preferably, there is space between the handle 40 and the trap 10 so that the handle can be grasped without being uncomfortably close to the insect trap. The legs 62, 70 need not be integrally formed with the frame 34, but are optionally separately formed and attached to the frame. Where two or more wheels 36 are present, a single leg 62 is sufficient to stably support the frame 34, tank 14 and insect trap 10.

At the bottom of each leg 62, 70, the front portion 50 of the frame 34 and the back portion 52 turn toward each other and turn upwardly to form the handle 40. Looking at the frame 34 from the handle side, the frame resembles an elongated “W” from each leg 62, 70 and the handle 40 in the middle. An optional hand grip 78 around the handle 40 makes the handle more comfortable to hold and less likely to slip than the bare frame 34. As shown, the handle 40 is approximately the same height as the bottom of the trap 10, however, this height is not critical and optionally varies from the embodiment shown here.

Although one particular embodiment for the frame 34 has been shown and described, the exact shape of the frame can vary greatly within the scope of this invention. The only requirements are that the frame 34 support the tank 14 and the trap 10, and that there is at least one attachment bar 56 to which to secure the sling 74. Other configurations for the frame 34 are equally suitable, including those embodiments where the insect trap 10 is positioned closer to the axle 42 than the tank 14, embodiments where the insect trap or the tank is held by an intermediary apparatus such as a post, embodiments where the front portion 50 and back portion 52 of the frame 34 are not symmetrical and embodiments where the handle 40 is a part of or attached to either the tank 14 or the trap 10.

Referring to FIGS. 1, 2 and 3, the sling 74 wraps around the gas cylinder 14 and attaches to one or more attachment bars 56, 66. Materials from which the sling 74 is made include metals, plastics and fabrics. Preferably, the sling 74 is made from a fabric that is slightly elastic. The elasticity should be enough that the fabric will make a smooth fit and conform to the exact shape of the tank 14. However, the fabric is not so elastic that it permits the tank 14 to slide out of position on the cart 12 when it is being moved. The preferred material is vinyl due to its degree of elasticity and its durability in an outdoor environment. Non-elastic fabrics are also suitable, including natural or synthetic materials, however they may bunch or gather where there is excess material. Rigid materials are also contemplated for manufacture of the sling 74. For example, a rigid plastic, such as polypropylene, could be molded into an appropriate shape and pivotally attached to the attachment bar 56. When the tank 14 is in place, the sling 74 could be swung into position and releasably fastened, holding the tank in place.

In shape, the sling 74 is preferably elongated, having two short sides, a first short side 80 and a second short side 82, and two long sides, a first long side 84 and a second long side 86. The long sides 84, 86 must be sufficiently long to be attached to the front attachment bar 56, wrap around the tank or cylinder 14 and be releasably attached to the same or a back attachment bar 66. As shown, the two short sides 80, 82 are attached to the front attachment bar 56 and the back attachment bar 60.

The exact size and shape of the sling 74 will vary depending on the size of the tank 14, the materials from which it is made, the shape of the frame 34. Excess material should be minimized to prevent the tank 14 from shifting position during movement of the cart 12. Straight or arcuately shaped sides 80, 82, 84, 86 are preferred. When the preferred vinyl fabric is used, the sling 74 is substantially flat. If rigid materials are used, the sling 74 is preferably molded to fit the tank 14 securely, optionally having approximately a “C” shape when viewed from above the tank. The sling 74 preferably fits around a side 88 of the tank below a collar 89 but above a tank bottom 90. Optionally, the sling 74 tapers from the middle of the long sides 84, 86 to the short sides 80, 82.

Referring to FIGS. 4 and 5, the first short side 80 is attached to the back attachment bar 66 by any attaching device 91 that is sufficient to support the tank 14. Preferably, at least one short side 80, 82 of the sling 74 is permanently attached to the frame 34. If the sling 74 is easily removable, consumers may not use it, creating a potential hazard of the tank 14 falling when the cart 12 is moved. The sling 74 is attached either directly to the frame 34, or it is optionally wrapped around the frame 34 and attached to itself. Preferred methods of attaching the sling include 74 stitching or the use of any type of attaching device 91, such as fasteners including grommets, rivets, bolts or screws. Use of a sleeve 92 as an attachment device 91 is contemplated, through which the frame 34 would be inserted. The sleeve 92 could be made by stitching the fabric, weaving it into the fabric, molding it into a rigid plastic and the like. Where the sling 74 is made of a rigid material, it is contemplated that it be able to pivot to release the tank 14 for replacement.

The second short side 82 of the sling 74 is releasably attached to the frame 34 with a releasable fastener 93 to permit release of a tank 14 for replacement. Any method of attaching the tank 14 is suitable that permits removal of a used tank and installation of a full one. Preferably, the releasable fasteners 93 include buckles, snaps, hooks, straps or hook and loop fasteners. Most preferably, the sling 74 is attached using VELCRO® brand hook and loop fasteners. In some embodiments, the hook portion 94 of the hook and loop fastener system is attached to the sling 74 in a position from which it is convenient to wrap it around the attachment bar 56. The hook portion 96 of the hook and loop system is positioned on the sling 74 to receive the hook portion 94 when it has been wrapped around the attachment bar 56 and the sling is in position to provide support to the tank 14. Alternately, either the hook 94 or loop portion 96 is positionable on the frame.

Although the permanent attaching device 91 is shown and described as being on the back attachment bar 66 and the releasable fastener 93 is shown on the front attachment bar 56, any type of attaching device 91 is suitably used on any attachment bar 56, 66.

Referring back to FIG. 1, the sling 74 should be of a color and pattern that is neutral to the mosquitoes 20, that is, it should neither attract the insects 20 away from the capture zone nor repel them from the area surrounding the trap 10. Preferably the sling 77 is gray, blue or an earthtone color. Light colors are preferred over dark colors. Particularly preferred embodiments of this invention include slings 74 that are light green, light blue, light gray and beige. Solid colors are preferred, however, patterns are useful as long as mosquitoes 20 are neither attracted or repelled by them.

To be effective in reducing the effect of the tank for attracting or repelling mosquitoes, the sling 74 preferably covers at least about 30% of the surface area of the tank 14. Preferably, the sling 74 covers more than 40% of the tank surface are or more than 50% of the tank surface area. Most preferably, the sling 74 covers at least 60% of the tank surface area. Coverage of a large part of the tank 14 by the sling 74 provides both improved stability for the tank as well as additional camouflage from the mosquitoes 20.

In use, the tank retention sling 74 is attached to the frame 34 prior to placing the cart 12 into service. This can be done during manufacture, or the user could be directed to attach the sling 74 during assembly of the cart 12.

Looking now to FIG. 3, when the cart 12 and insect trap 10 are ready for use, at least one short side 80, 82 of the sling 74 is releasably detached and the sling is moved to provide access to the cart 12 by the tank cylinder 14. The tank 14 is placed on the tank supports 54, 64 and placed in contact with the standoff 77. The sling 74, which has been decorated with a color or pattern that is neutral to insects, is wrapped around the side of the tank 88 and attached to the front attachment bar 56. The cart 12 is then moveable to any location with the tank 14 held securely in place.

While specific embodiments of the tank retention sling of the present invention have been shown and described for an insect trap, it will be appreciated by those skilled in the art that changes and modifications may be made thereto without departing from the invention in its broader aspects and as set forth in the following claims. Any type of insect trap that utilizes a gas tank with the insect trap can utilize the tank retention sling of this invention.

1. A tank cart for an LP tank comprising:
a cart configured for holding an LP tank, the cart including a frame and at least one wheel;
a generally rigid attachment bar on a portion of said frame;
an elongated sling wrapped around a side of the LP tank; and
a means for releasably attaching said sling to said frame to support the tank against said frame when said cart is moved.

2. The tank cart of claim 1 wherein said attachment bar comprises at least a first attachment bar and a second attachment bar on said frame, said sling comprises a first end and a second end, and wherein said first end of said sling attaches to said first attachment bar and said second end of said sling attaches to said second attachment bar.

3. The tank cart of claim 2 wherein said first end is permanently attached to said first attachment bar and said second end is removably attached to said second attachment bar.

4. The tank cart of claim 1 wherein said means for releasably attaching sling comprises hook and loop fasteners.

5. The tank cart of claim 1 wherein said sling is flexible.

6. The tank cart of claim 5 wherein said sling is made from a synthetic fabric.

7. The tank cart of claim 1 wherein at least one color of said sling is selected to neither attract nor repel insects.

8. The tank cart of claim 1 wherein said attachment bar is located between said wheels and a handle.

9. The tank cart of claim 8 wherein said handle is positioned below the top of the LP tank when the tank is installed on said cart.

10. An insect trap including a fuel tank comprising:
an insect trap that generates insect attractants by burning fuel;
a fuel tank supplying the fuel;
a cart configured for holding said fuel tank and said insect trap, comprising a frame, at least one wheel and a handle;
a generally rigid attachment bar on said frame;
an elongated sling wrapped around a side of said fuel tank and releasably attached to said attachment bar.

11. The insect trap of claim 10 wherein said sling covers at least 30% of the fuel tank surface.

12. The insect trap of claim 10 wherein at least one color of said sling is selected to neither attract nor repel insects.

13. The insect trap of claim 10 wherein said attachment bar comprises at least a first attachment bar and a second attachment bar and said sling comprises a first end and a second end, and wherein said first end of said sling attaches to said first attachment bar and said second end of said sling attaches to said second attachment bar.

14. The tank cart of claim 13 wherein said first end is permanently attached to said first attachment bar and said second end is removably attached to said second attachment bar.

15. The insect trap of claim 10 wherein said sling removably attaches to said attachment bar using hook and loop fasteners.

16. The insect trap of claim 10 wherein at last 30% of the tank surface is covered by said sling.

17. A method of attracting insects to an insect trap comprising:
providing a cart for moving an insect trap and a fuel tank;
stabilizing the tank for moving the cart by attaching a first end of an elongated sling to the cart, wrapping the sling around the tank and removably attaching a second end of the sling to the cart;
generating attractant gases by combusting the fuel; and
luring insects to the insect trap by releasing the attractant gases.

18. The method of claim 17, further comprising decorating the sling with a color or pattern that neither attracts nor repels insect.

19. The method of claim 17, wherein wrapping the sling around the tank further comprises covering at least 30% of the tank surface with the sling.
